(19) United States
(12) Patent Application Publication
(10) Pub. No.: US 2004/0222763 A1
(43) Pub. Date: Nov. 11, 2004

(54) Brushless dc motor applied to ac power

(75) Inventors: Wen-Shing Wu, Kaohsiung Hsien (TW); Alex Horng, Kaohsiung (TW)

Correspondence Address: BACON & THOMAS, PLLC, 625 SLATERS LANE, FOURTH FLOOR, ALEXANDRIA, VA, 22314

(73) Assignee: Profantec Development Corp., Kaohsiung Hsien (TW)

(21) Appl. No.: 10/448,391

(22) Filed: May 30, 2003

(30) Foreign Application Priority Data
May 9, 2003 (TW) 92208553

(51) Int. Cl. H02P 7/00

(52) U.S. Cl. 318/441

(57) ABSTRACT

A brushless dc motor applied to ac power in accordance with the present invention includes a conversion circuit. The conversion circuit includes a metallized film capacitor, a rectifier and a filter. The metallized film capacitor is serially connected to an ac power source, and adapted to supply with a rated ac voltage for the brushless de motor. The metallized film capacitor is further serially connected to the rectifier and the filter. The rectifier is converted an alternating current supplied from the metallized film capacitor into a direct current. The filter is filtered the direct current supplied from the rectifier and then sent to a motor drive circuit.

### BACKGROUND OF THE INVENTION

1. Field of the Invention

The present invention is related to a brushless dc motor applied to ac power. More particularly, the present invention is related to a metallized film capacitor of a brushless dc motor adapted to control an ac power source, thereby supplying an ac voltage which is suitable for use of the brushless dc motor and able to be converted into a dc voltage.

2. Description of the Related Art

Referring to FIG. 1, U.S. Pat. No. 6,278,248, entitled “BRUSHLESS DC MOTOR FAN DRIVEN BY AN AC POWER SOURCE,” issued on Aug. 21, 2001 to HORNG et al, discloses a brushless dc motor fan. The brushless dc fan motor includes a converter circuit 1 consisted of a bridge rectifier 11, a resistor 12 and a filter 13. The resistor 12 is adapted to step down a voltage of an ac power source so that a step-down voltage is suitable for use of the brushless de motor. The converter circuit 1 employs the bridge rectifier 11 to convert the step-down voltage into a de voltage and to supply it to a motor drive circuit 2 and a sensor element 20. Consequently, the application of the brushless dc motor fan is suitable for ac power and may not be limited by a necessity of dc power.

However, an ac voltage supplied from a distributed power source is transformed into a low ac voltage that is suitable for a miniature brushless dc motor, as the resistor 12 of the converter circuit 1 is functioned. For example, ac 10 V is transformed into ac 12 V or ac 220 V into ac 24 V. In this circumstance, the power consumption of the resistor 12 may result in a successive production of great heat. Thus, the brushless dc motor must be overheated in the normal operation when it is normally operated.

In addition, once the brushless motor is jammed, locked or failed, a rated current passed through the resistor 12 is suddenly increased that the power consumption of the resistor 12 may be increased. Consequently, the motor components including the resistor 12 may be destroyed if the power consumption is exceeded.

Referring to FIG. 2, U.S. Pat. No. 6,278,248 further discloses another converter circuit 1′ consisted of a capacitor set 14, a resistor set 15 and a zenor diode 16. The capacitor set 14 is a set of electrolytic capacitors adapted to filter power, and has a key feature of high Dissipation Factor (DF) that may result in a successive production of great heat. Similarly, the resistor set 15 may also result in a successive production of great heat.

The present invention intends to provide a brushless dc motor applied to ac power supplied from a distribruted power source. The brushless dc motor includes a metallized film capacitor adapted to control and stabilize an ac power source. The metallized film capacitor has features of low dissipation factor and stabilized capacity that may not cause overheating during operation. The ac voltage supplied from the metallized film capacitor is converted into a dc voltage that is suitable for a drive circuit of the miniature motor.

### SUMMARY OF THE INVENTION

The primary objective of this invention is to provide a brushless dc motor applied to ac power, which includes a metallized film capacitor adapted to provide with a stabilized ac voltage suitable for applying to the dc brushless motor Since the metallized film capacitor has features of low dissipation factor and stabilized capacity, it may not cause overheating during operation. Thereby, the useful life of the brushless dc motor is prolonged.

The secondary objective of this invention is to provide a brushless dc motor applied to ac power, which simply employs a metallized film capacitor adapted to provide with a stabilized ac voltage suitable for applying to the brushless dc motor. The brushless dc motor further includes a rectifier adapted to convert the ac voltage into a dc voltage, and a filter adapted to filter the dc voltage. Thereby, the circuitry structure of the brushless dc motor is simplified.

The brushless dc motor applied to ac power in accordance with the present invention includes a conversion circuit. The conversion circuit includes a metallized film capacitor, a rectifier and a filter. The metallized film capacitor is serially connected to an ac power source, and adapted to supply with a rated ac voltage for the brushless dc motor. The metallized film capacitor is further serially connected to the rectifier and the filter. The rectifier is converted an alternating current supplied from the metallized film capacitor into a direct current. The filter is filtered the direct current supplied from the rectifier and then sent to a motor drive circuit.

Other objectives, advantages and novel features of the invention will become more apparent from the following detailed description and the accompanying drawings.

### BRIEF DESCRIPTION OF THE DRAWINGS

The present invention will now be described in detail with reference to the accompanying drawings herein:

FIG. 1 is a schematic diagram of a converter circuit for a brushless dc motor fan in accordance with the prior art;

FIG. 2 is a schematic diagram of another converter circuit for a brushless dc motor fan in accordance with the prior art; and

FIG. 3 is a schematic diagram of a conversion circuit for a brushless dc motor applied to ac power in accordance with the present invention.

### DETAILED DESCRIPTION OF THE INVENTION

Referring to FIG. 3, it illustrates a schematic diagram of a conversion circuit for a brushless dc motor applied to ac power in accordance with the present invention.

Referring again to FIG. 3, a brushless dc motor applied to ac power in accordance with the present invention a conversion circuit 3. The conversion 3 is serially connected between a distributed ac power source and a brushless dc motor 4. The conversion 3 is adapted to convert an ac voltage supplied from a distributed power source into a dc voltage, such as 24 V, that is suitable for the miniature brushless dc motor. The conversion 3 includes a metallized film capacitor 31, a rectifier 32 and a filter 33. The metallized film capacitor 31 is serially connected to the rectifier 32 and the filter 33.

The metallized film capacitor 31 is selected from a metallized polyester film capacitor or a metallized polypropylene film capacitor. Preferably, the metallized film capacitor 31 is a roll of a polyester film and a polypropylene film that has a slight change of the capacitance and the dissipation factor within temperature of −40 degrees centigrade through 75 degrees centigrade. When the metallized film capacitor 31 is charged and discharged by the ac power source, the surface temperature of the metallized film capacitor 31 is only raised about 5 degrees centigrade due to the features of low dissipation factor and stabilized capacitance.

When charging and discharging the metallized film capacitor 31 control the conversion circuit 3, an ac voltage is supplied to the brushless dc motor 4. The metallized film capacitor 31 has an appropriated capacitance so that an ac power source is stepped down to provide with a suitable ac voltage for a miniature brushless dc motor without overheating. For example, the metallized film capacitor 31 has a capacitance of 1 F for stepping down 380 V to 24 V, 2 F for stepping down 220 V to 24 V, and 3 F for stepping down 10 V to 24V.

The rectifier 32 is serially connected between the metallized film capacitor 31 and the filter 33. Preferably, the rectifier 32 is a bridge rectifier and adapted to convert the step-down ac voltage into a dc voltage. When the step-down ac voltage supplied from the metallized film capacitor 31 is sent to the rectifier 32, it is converted into a dc voltage.

The filter 33 is serially connected between the rectifier 32 and the brushless dc motor 4. Preferably, the filter 33 is a capacitor and adapted to filter the dc voltage for providing a stabilized dc voltage. When the converted dc voltage supplied from the rectifier 32 is sent to the filter 33, it is stabilized and then sent to a motor drive circuit of the brushless dc motor.

When the brushless dc motor 4 is operated normal, charging and discharging the metallized film capacitor 31 is regular. Consequently, the conversion circuit 3 is able to supply the regular direct current and the stabilized dc voltage to the brushless dc motor 4.

Once the brushless de motor 4, by the use of the metallized film capacitor 31, is jammed, locked or failed, however, charging and discharging of the metallized film capacitor 31 is automatically reduced half. Consequently, the brushless dc motor and motor components thereof can avoid being overheated.

When the failure of the brushless dc motor is removed, charging and discharging of the metallized film capacitor 31 is automatically become regular.

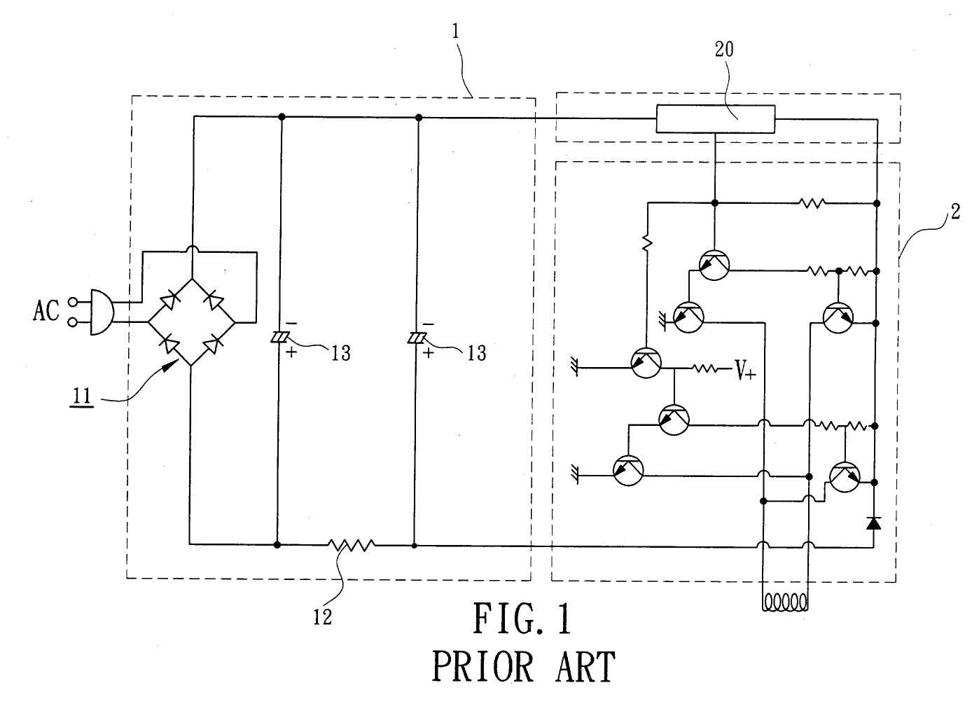

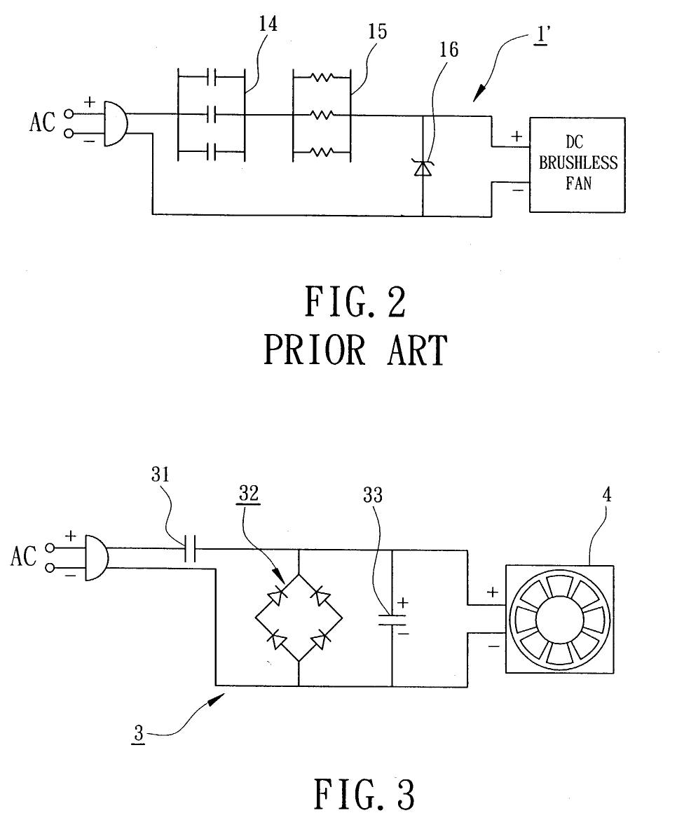

The power consumption of the resistor 12 of the converter circuit 1, as shown in FIG. 1, and the resistor 15 of the converter circuit 1′, as shown in FIG. 2, may result in a successive production of great heat for stepping down the ac voltage. In normal operation, the brushless dc motor fan must be overheated. Once the brushless motor fan is jammed, locked or failed, the alternating current passed through the resistors 12 and 15 are rapidly increased that may result in an increase of the power consumption of the resistors 12 and 15. Consequently, the resistors 12 and 15 are overheated and destroyed.

By contrast, referring again to FIG. 3, when charging and discharging of the metallized film capacitor 31 of the conversion circuit 3 actuates the brushless dc motor 4 in normal, howevere, it may not result in being overheated. Once the brushless dc motor 4 is jammed, locked or failed, the metallized film capacitor 31 may automatically allow a slight current passing through the brushless dc motor 4. Consequently, the destruction of the brushless de motor 4 is avoided.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A conversion circuit for a brushless dc motor, comprising:
a metallized film capacitor electrically connected to an ac power source, and adapted to provide with a step-down ac voltage for the brushless dc motor;
a rectifier connected to the metallized film capacitor, and adapted to convert the step-down ac voltage supplied from the metallized film capacitor into a dc voltage; and
a filter connected to the rectifier, and adapted to filter the dc voltage supplied from the rectifier for supplying a stabilized de voltage to the brushless dc motor.

2. The conversion circuit for the brushless de motor as defined in claim 1, wherein the metallized film capacitor is a metallized polyester film capacitor.

3. The conversion circuit for the brushless de motor as defined in claim 1, wherein the metallized film capacitor is a metallized polypropylene film capacitor.

4. The conversion circuit for the brushless dc motor as defined in claim 1, wherein the rectifier is a bridge rectifier.

5. The conversion circuit for the brushless de motor as defined in claim 1, wherein the filter is a capacitor.

6. The conversion circuit for the brushless de motor as defined in claim 1, wherein the filter is connected to a motor drive circuit of the brushless de motor.

7. The conversion circuit for the brushless dc motor as defined in claim 1, wherein the metallized film capacitor is a roll of a polyester film and a polypropylene film.
